(19) United States
(12) Patent Application Publication
(10) Pub. No.: US 2021/0252847 A1
(43) Pub. Date: Aug. 19, 2021

(54) BOTTLE CAN AND MANUFACTURING METHOD THEREOF

(71) Applicant: UNIVERSAL CAN CORPORATION, Tokyo (JP)

(72) Inventors: Takashi Kagawa, Sunto-gun (JP); Akira Murayama, Sunto-gun (JP)

(73) Assignee: UNIVERSAL CAN CORPORATION, Tokyo (JP)

(21) Appl. No.: 17/273,595

(22) PCT Filed: Feb. 3, 2020
(86) PCT No.: PCT/JP2020/003879

§ 371 Date: Mar. 4, 2021

(30) Foreign Application Priority Data
Feb. 4, 2019 (JP) 2019-017792

(51) Int. Cl. B41F 17/22; B41M 1/02; B41M 1/28; B21D 51/26

(52) U.S. Cl. CPC B41F 17/22; B21D 51/2638; B41M 1/28; B41M 1/02

(57) ABSTRACT

A manufacturing method comprises: a printing step printing on an outer peripheral surface of a cylinder part of a cylinder body; a necking step deforming the cylinder body after the printing step to form a tapered part in which a diameter is reduced upward from the cylinder part and a small-diameter part extending to an upper side of the tapered part; and a mouth part forming step deforming the small-diameter part to form the mouth part including a swelled part and a male thread part. In the printing step, ink is coated on a third coating region to be the cylinder part, a fourth coating region to be the tapered part, and a first coating region to be the swelled part. An apply amount of the ink per unit area on the first coating region is less than that of the ink per unit on the third coating region.

### CROSS-REFERENCE TO RELATED PATENT APPLICATIONS

This application is a U.S. National Phase Application under 35 U.S.C. § 371 of International Patent Application No. PCT/JP2020/003879 filed on Feb. 3, 2020 and claims the benefit of priority to Japanese Patent Application No. 2019-017792, filed Feb. 4, 2019, all of which are incorporated herein by reference in their entireties. The International Application was published in Japanese on Aug. 13, 2020 as International Publication No. WO/2020/162383 under PCT Article 21(2).

### FIELD OF THE INVENTION

The present invention relates to a bottle can which is filled with a content such as a beverage and a manufacturing method thereof.

### BACKGROUND OF THE INVENTION

As a can body filled with content such as beverage and sealed, a bottle can with a cap attached to an opening end part of a can is known. In a necking step of the bottle can, a diameter reduction ratio is larger than that of what is called a two-piece can; on the mouth part which is reduced in the diameter, a swelled part and a male thread part are formed. In such a bottle can, printing is performed on a cylindrical cylinder body having a base part after a drawing-ironing step and a trimming step.

As a method of printing on an outer surface of such a cylinder body, methods described in Japanese Unexamined Patent Application, First Publication No. S63-162241 and Japanese Unexamined Patent Application, First Publication No. 2002-36710 are known.

The method described in Japanese Unexamined Patent Application, First Publication No. S63-162241 is a printing method using relief printing: a method in which ink is applied to protruded parts of a printing block having protrusions and dents and transferred on the cylinder body.

The method described in Japanese Unexamined Patent Application, First Publication No. 2002-36710 is a printing method using waterless planography: a method in which an ink repelling part in the other part than an image part is made of silicone resin and ink is applied to the image part and transferred on the cylinder body.

In both cases, the ink is transferred on the cylinder body from a printing plate by a blanket.

### CITATION LIST

Patent Document 1: Japanese Unexamined Patent Application, First Publication No. S63-162241
Patent Document 2: Japanese Unexamined Patent Application, First Publication No. 2002-36710

### Technical Problem

Recently, in view of improving design of a bottle can, it is desired that aluminum basis of the bottle can which is not printed is not seen through slits formed on a cap.

However, in order not to be seen the aluminum basis through the slits of the cap, in a case in which a swelled part positioned at a lower end part of a mouth part of a bottle can is also printed as in a cylindrical part, by a necking step after a printing step, a printing area is spread to the male thread part not only the swelled part because an aluminum alloy sheet which becomes material of the bottle can is different in elongation between a rolling direction and a cross direction thereto. In this case, a paint film is roughened when a thread is formed on the bottle can or a subsequent step, and open torque of the cap may be increased.

The present invention is achieved in consideration of the above circumstances, and has an object to provide a bottle can in which peeling of printing when a cap is opened or increase of torque when opened can be reduced and a manufacturing method thereof.

### SUMMARY OF THE INVENTION

### Solution to Problem

A manufacturing method of a bottle can of the present invention is provided with: a printing step printing on an outer peripheral surface of a cylinder part of a cylinder body, a necking step forming a tapered part in which a diameter is reduced upward from the cylinder part and a small-diameter part extending toward the upper side of the tapered part by deforming the cylinder body after the printing step, and a mouth part forming step forming the mouth part having a swelled part and a male thread part by deforming the small-diameter part; in the printing step, ink is applied on a third coating region to be the cylinder part, a fourth coating region to be the tapered part, and a first coating region to be the swelled part, and an apply amount of the ink per unit area in the first coating region is less than an apply amount of the ink per unit in the third coating region.

Since the ink is applied on the swelled part of the mouth part in this invention, it is prevented that aluminum basis is exposed through slits formed on the cap when the cap is attached to the bottle cap. Moreover, design property is excellent since the swelled part is printed as in the cylinder part and the like.

Furthermore, since the apply amount of the ink per unit area on the first coating region to be the swelled part is less than the apply amount of the ink per unit on the fourth coating region to be the cylinder part, it is possible to reduce the thickness of the printed layer on the swelled part after the necking step and the mouth part forming step. Therefore, even in a case in which the printing spreads from the swelled part over a part of the male thread part, the thickness of the printed layer is small since the apply amount of the ink per unit area on the spread part is small, and the peelings of the printing when the cap is opened and the torque for opening can be reduced.

As a preferable aspect of the manufacturing method of a bottle can of this invention, it is preferable that an apply amount of the ink per unit area in the fourth coating region be less than the apply amount of the ink per unit area in the third coating area and gradually reduced upward.

Alternatively, as a preferable aspect of the manufacturing method of a bottle can of this invention, it is preferable that an apply amount of the ink per unit area in the fourth coating area be the same as the apply amount of the ink per unit area in the third coating area.

As a preferable aspect of the manufacturing method of a bottle can of the present invention, it is preferable that in the printing step, a first printing block transcribing the ink on both the first coating region and a second region including the third coting region and the fourth coating region and a second printing block transcribing the ink on the second coating region only be used.

In the above-described aspect, since the second printing block does not have a region to transcribing the ink to the first coating region, it is easy to reduce the apply amount of the ink per unit area on the first coating region by only printing using these two printing blocks.

As another preferable aspect of the manufacturing method of a bottle can of the present invention, in the printing step, one printing block be used having a first region transcribing the ink to the first coating region and a second region transcribing more amount of the ink than in the first region to the second coating region including the third coating region and the fourth coating region.

In the above-described aspect, since the outer peripheral surface of the cylinder body can be printed using one print block having the first region and the second region, the printing step is simplified and the manufacturing cost can be reduced.

As another preferable aspect of the manufacturing method of a bottle can of the present invention, it is preferable that in the printing step, the first coating region and a second coating region including the third coating region and the fourth coating region be dot printed; and a dot density of the ink printed on the second coating region be higher than a dot density of the ink printed on the first coating region.

In the above-described aspect, just by changing the dot densities of the ink printed on the first coating region and the second coating region, the apply amount of the ink per unit area on the first coating region can be reduced comparing to the apply amount of the ink per unit area on the second coating region.

As another preferable aspect of the manufacturing method of a bottle can of the present invention, it is preferable that in the printing step, the first coating region be dot printed and a second coating region including the third coating region and the fourth coating region be solid printed.

In the above-described aspect, the first coating region is dot printed and the second coating region is solid printed, so that the apply amount of the ink per unit area on the first coating region can be reliably small than the apply amount of the ink per unit area on the second coating region.

As another preferable aspect of the manufacturing method of a bottle can of the present invention, it is preferable that in the printing step, using a first printing block transcribing the ink to both the first coating region and a second coating region including the third coating region and the fourth coating region, the first coating region be dot printed and the second coating region be solid printed; and using a second printing block transcribing the ink to both the first coating region and the second coating region, the first coating region and the second coating region be solid printed.

In the above-described aspect, since the second coating region is solid printed twice, the cylinder part and the tapered part can have good appearance. Regarding the first coating region, since the solid printing is carried out after the dot printing is carried out, the apply amount of the ink on the first coating region can be reliably smaller than the apply amount of the ink on the second coating region.

A bottle can of the present invention includes a cylinder part, a tapered part in which a diameter is reduced upward from a top end of the cylinder part, and a mouth part which is provided at an upper side of the tapered part and has a swelled part swelled outward in a radial direction and a male thread part; in the bottle can, a printed layer is formed on the cylinder part, the tapered part and the swelled part, and a thickness of the printed layer on the swelled part is smaller than a thickness of the printed layer on the cylinder part.

In the present invention, since the printed layer is formed on the swelled part of the mouth part, it is possible to prevent the aluminum basis from being seen through the slits formed on the cap when the cap is attached to the bottle can. Moreover, since the swelled part is also printed as in the cylinder part and the like, the design is excellent.

Furthermore, since the thickness of the printed layer of the swelled part is smaller than the thickness of the printed layer of the cylinder part, the peelings of the printing is prevented when the cap is opened and the torque for opening can be reduced, even in a case in which the printing spreads from the swelled part over a part of the male thread part.

### Advantageous Effects of Invention

According to the present invention, in a bottle can in which a cylinder body after a printing step is machined to be largely deformed, adhesiveness of ink is improved, peeling of printing when a cap is opened and increase of torque when opening can be reduced, and color tone of a printing surface can be made even.

### BRIEF DESCRIPTION OF THE DRAWINGS

FIG. 1 is a frontal view schematically showing a cylinder body in which an outer peripheral surface is printed in the middle of manufacturing a bottle can.

FIG. 2 is a frontal view showing a cap and a bottle can manufactured from the cylinder body shown in FIG. 1, and a cap.

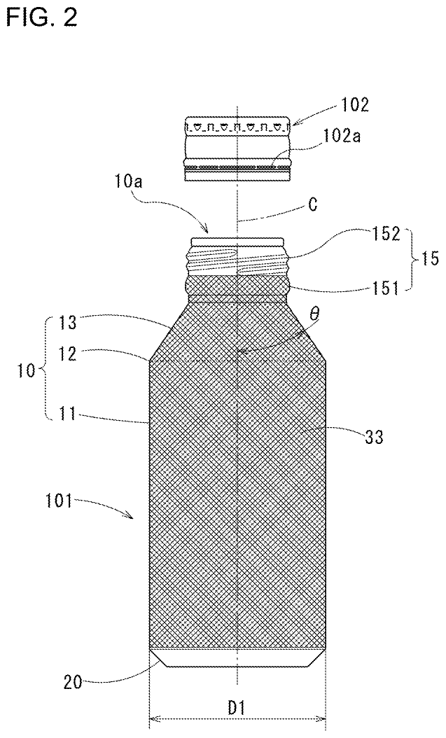

FIGS. 3A-3C are drawings showing a manufacturing process of the bottle can of the above-described embodiment in order: FIG. 3A and FIG. 3B each is a vertical cross-sectional view on a can axis, and FIG. 3C is a frontal view.

FIG. 4 is a schematic view showing an outline structure of a printer for printing an outer peripheral surface of the cylinder body.

FIG. 5 is a frontal view schematically showing a modified example of the above-described embodiment; and a distribution of dot density of the printed layer is shown at the left side.

### DETAILED DESCRIPTION OF THE INVENTION

An embodiment of the present invention will be explained below with referring the drawings. A bottle can 101 manufactured by a manufacturing method of the present embodiment is formed of a thin sheet metal such as aluminum or aluminum alloy; and is formed as a cylindrical shape with a base including a mouth part 15, a cylindrical body part 10, and a dome shape base part 20.

The body part 10 includes a cylinder part 11 formed to be a cylindrical shape at the base part 20 side, a shoulder part 12 which is reduced in a diameter to curve inward in a radial direction on an upper end of the cylinder part 11, and a tapered part 13 which is reduced in a diameter upward in a can axis C direction (toward an opening part 10a side).

The mouth part 15 is formed on the upper end of the tapered part 13 and includes a belt-shape swelled part 151 swelling outward in the radial direction and a male thread part 152 positioned at an upper side in the can axis C direction of the swelled part 151. The swelled part 151 is used for seaming a hem of a cap 102.

The bottle can 101 of the present embodiment is used for a can in which an outer diameter D1 of the cylinder part 11 in the body part 10 is not less than 64.24 mm and not more than 68.24 mm (nominal 211 diameter); however, it is not limited to this. A major diameter of the thread of the mouth part 15 is formed to be 38 mm for example. An inclined angle θ by the tapered part 13 and the can axis C of the cylinder part 11 is not less than 10° and not more than 41° for example.

An inside of the bottle can 101 is sealed by screw-forming machining the cap 102 covering the mouth part 15 to fit the male thread part 152 of the mouth part 15. A hem of the cap 102 is seamed on the swelled part 151 and the cap 102 is mounted on the bottle can 101, so that the swelled part 151 is covered with the cap 102, and a part of the swelled part 151 can be seen through slits 102a formed on the cap 102 from the exterior.

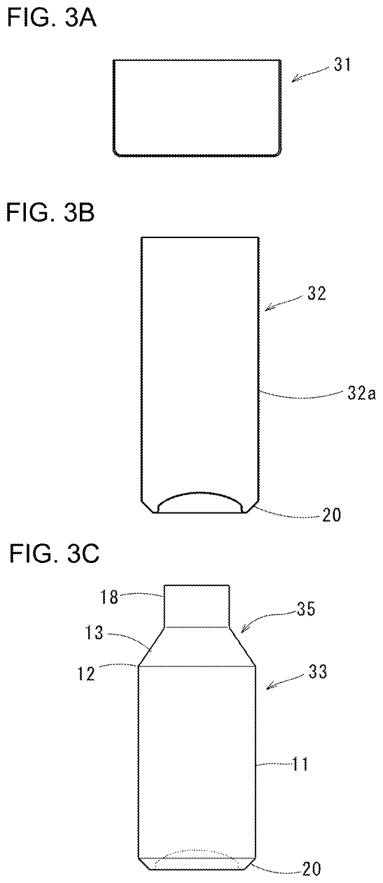

In order to form the bottle can 101, first, a shallow cup 31 is formed with relatively a large diameter as shown in FIG. 3A by punching an aluminum sheet material and drawing it (a cup forming step).

Then, by machining the cup 31 by drawing and ironing again (DI machining), a cylinder body 32 which is a cylindrical shape having a base with a prescribed height is formed as shown in FIG. 3B (a DI step). By the drawing and ironing machining, an edge part (an uneven shape) is generated at an upper end part of the cylinder body 32; therefore, the upper end part is trimmed so as to make an even height state (a trimming step). By the drawing and ironing machining, a base part of the cylinder body 32 is formed into a shape of the base part 20 as the final bottle can 101.

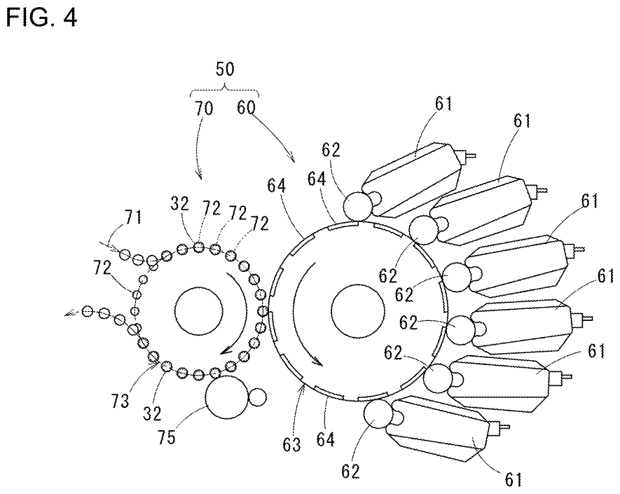

Next, after degreasing and performing a chemical treatment on the cylinder body 32, a base layer (illustration is omitted) is formed as necessary, supplying to a printing machine 50 (FIG. 4), performing printing on an outer peripheral surface 32a (a printing step: forming a printed layer 33) and forming a transparent overcoat (or finishing varnish) on a whole of the outer peripheral surface 32a including the printed layer 33 (FIG. 3C) (a coating step), and baking the printed layer 33 and the overcoat to dry them by making the cylinder body 32 pass through an oven after printing and coating (an outer surface printing and coating step).

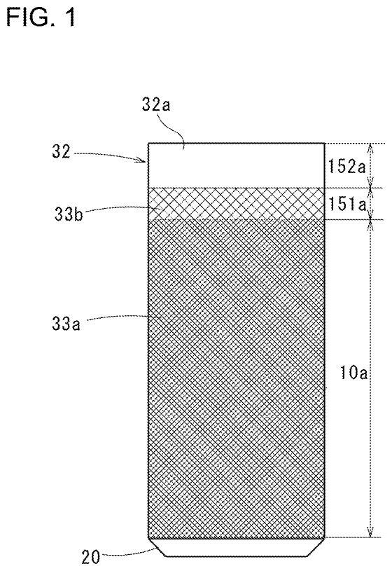

FIG. 1 shows the cylinder body 32 after the outer surface printing and coating step. The base layer (illustration is omitted) under the printed layer 33 and the overcoat (illustration is omitted) on the printed layer 33 are both formed with a larger area than the printed layer 33.

The base layer is formed by applying, for example polymer polyester-amino resin type, transparent paint or white coat in which white pigment such as titanium white is added, for a sake of improving adhesiveness between the cylinder body 32 and the printed layer 33 and the like.

The printing machine 50 for forming the printed layer 33 and the overcoat is provided with an ink adhesion mechanism 60 and a can moving mechanism 70 as shown in FIG. 4. The ink adhesion mechanism 60 is structured from a plurality of inker units 61 supplying inks for respective colors and a blanket cylinder 63 getting in contact with printing plate cylinders 62 of the respective inker units 61 and taking the inks by transferring, and then transferring the ink on the outer peripheral surface 32a of the cylinder body 32 by getting in contact with the cylinder body 32. On respective outer peripheral surfaces of the printing plate cylinders 62, relief plates are formed in accordance with drawing pattern printed on the cylinder body 32. The blanket cylinder 63 has a plurality of blankets 64 on an outer periphery thereof on which the inks are transferred from the relieve plates of the printing plate cylinders 62.

The can moving mechanism 70 is provided with a supplying shooter 71 taking in the cylinder body 32, a plurality of mandrels 72 rotatably holding the cylinder body 32 supplied from the supplying shooter 71, and a mandrel turret 73 moving the cylinder body 32 mounted on each of the mandrels 72 to the blanket cylinder 63 side of the ink adhesion mechanism 60 in order. The cylinder body 32 after printing is moved to an oven (illustration is omitted) by being carried from the mandrels 72 to a chain conveyer (illustration is omitted). In the mandrel turret 73, on a middle position of conveying the cylinder body 32 after printing, a roll coater 75 is provided to paint a resin film (an overcoat) on the outer peripheral surface 32a of the cylinder body 32.

In the ink adhesion mechanism 60, the inks of the respective colors are transferred to the respective blankets 64 from the printing plate cylinders 62 in order as drawing patterns; and with the blankets 64, the cylinder body 32 rotatably held by the mandrels 72 is in contact and rolled, so that the outer peripheral surface 32a of the cylinder body 32 is printed (the printing step). After printing, the overcoat is applied on the whole outer peripheral surface 32a including the printed layer 33 by the roll coater 75 (the coating step). Drying and baking treatments are performed on the cylinder body 32 after the printing step and the coating step.

The overcoat formed on the printed layer 33 is for protecting the surface of the printed layer 33 and improving slippage; transparent paint such as acrylic resin, polyester resin, amino resin, epoxy resin or the like is used for it.

Subsequently, inner coating is performed by blowing paint on an inner peripheral surface of the cylinder body 32 by a spray or the like, and it is baked and dried (an inner surface paint step).

Then, as shown in FIG. 3C, a lower side part of the cylinder body 32 is the cylinder part 11 as it is, and an upper end part is formed to form the shoulder part 12, the tapered part 13, and a small-diameter part 18 by reducing the diameter at the upper part than the cylinder part 11 (a necking step). By this necking step, it becomes a bottle-shape can 35 in which the outline is a bottle shape; from the cylinder part 11 to the tapered part 13 becomes the final shape.

In the last step, the mouth part 15 having the swelled part 151 and the male thread part 152 is formed in the small-diameter part 18 (a mouth part forming step), so that the bottle can 101 is manufactured.

In the manufacturing process of the bottle can 101, in the outer surface printing and coating step, the printed layer 33 and the overcoat are formed on the outer peripheral surface 32a in a first coating region 151a to be the swelled part 151 and in a second coating region 10a to be the body part 10. That is to say, since the ink is printed on the swelled part 151, the aluminum basis can be prevented from being seen through the slits 102a formed in the cap 102 when the cap 102 is attached to the bottle can 101.

Here, if the apply amounts of the ink (per unit area) are the same the first coating region 151a and the second coating region 10a, the printed layer 33 in the swelled part 151 in which a diameter reduction ratio is large is thicker than that of the printed layer 33 in the cylinder part 11 in which the diameter reduction ratio is small. Furthermore, since the aluminum alloy sheet being material of the bottle can 101 extends differently between in a rolling direction and an orthogonal section thereto; there is a case in which the printed area be extended to the male thread part 152 not only to the swelled part 151.

In a case in which the thick printed layer 33 is extended to the upper part than the swelled part 151, there is a concern that the coated film turns rough when the thread of the bottle can 101 is formed or in the subsequent step, and an open torque of the cap 102 is high. Accordingly, in order not to form the thick printed layer 33 on the male thread part 152, the apply amount of ink (per area) is regulated in the outer surface printing and coating step.

FIG. 1 shows the outer peripheral surface 32a of the cylinder body 32 after the outer surface printing and coating step. On the outer peripheral surface 32a, a second printed layer 33a is formed on the second coating region 10a to be the body part 10 excepting a small area from the base part 20; and a first printed layer 33b is formed on the first coating region 151a to be the swelled part 151 of the mouth part 15. The ink is not applied on a male thread forming planned region 152a to be the male thread part 152 of the mouth part 15.

The apply amount of the ink (per unit area) in the second printed layer 33a formed on the second coating region 10a to be the body part 10 is less than the apply amount of the ink per unit area of the first printed layer 33b formed in the first coating region 151a to be the swelled part 151.

Offset printing style can be applied for printing on the outer peripheral surface 32a. As described above, the respective colors of inks are adhered on the printing plate cylinders 62 respectively provided for the colors, transferred once from the printing plate cylinders 62 to the blankets 64 in order, and transferred to the outer peripheral surface 32a from the blankets 64. As the printing plate cylinders 62 using a relief prate and a waterless planography printing plate, a printing image is structured by a number of dots by protrusions of the relief plate and lines of the waterless planography printing plate.

In order to make the apply amount of the ink different between the first coating region 151a and the second coating region 10a, density (screen ruling) of the dots formed by the printing plate cylinders 62 are made different, and density of the dots forming the first printed layer 33b (apply amount per unit area) is made smaller than density of dots forming the second printed layer 33a.

For example, when it is possible that the screen ruling be 80 lines to 175 lines and a minimum diameter of the dots be 38 μm, the dot density can be different by making the screen ruling different with a same dot diameter, or making the dot diameter different with the same screen ruling, or making both the screen ruling and the dot diameter different.

Where the dot density of the printed layer 33 is 100%, the dot density of the first printed layer 33b is made small in a range of less than 100% to 60%. Alternatively, the second printed layer 33a is dot printing with a specified density and the first printed layer 33b is dot printing with a smaller density than the dot density in the second printed layer 33a. In this case, the color tone of the first coating region 151a is lighter than that of the second coating region 10a in accordance with the difference of the apply amount of the ink in a state of the cylinder body 32; however, the color tone is as darker as the diameter reduction ratio is larger; accordingly, the color ton of the swelled part 151 in a state of the bottle can 101 approaches the color tone of the body part 10.

As explained above, since the printed layer 33 is formed on the swelled part 151 in the bottle can 101, the aluminum basis of the bottle can 101 is prevented from being exposed through the slits 102a formed on the cap 102 attached to the bottle can 101. Moreover, since the swelled part 151 is also printed as well as the cylinder part 11 and the like, design is excellent.

Furthermore, since the apply amount of the ink per unit area on the first coating region 151a is less than the apply amount of the ink per unit area on the second coating region 10a, the thickness of the printed layer 33 formed at the upper part than the swelled part 151 is small even when the first coating region 151a is unevenly extended to form a part of the male thread part 152 by the necking step and the mouth part forming step, so it is possible to reduce the print peeling when the cap 102 is opened and increase of the opening torque.

Since the printing plate cylinders 62 printing on the outer peripheral surface 32a in the printing step (the outer surface printing and coating step) have both the first region that transfers the ink on the first coating region 151a and the second region that transfers a larger amount of the ink on the second coating region 10a than the first region, one color can be printed on the outer peripheral surface 32a by one printing plate cylinder 62, so that the printing step can be simplified and the manufacturing cost can be reduced.

Moreover, only by changing the dot density of the ink printed on the first coating region 151a and the second coating region 10a, the apply amount of the ink per unit area on the first coating region 151a can be less than the apply amount of the ink per unit area on the second coating region 10a.

The present invention is not limited to the above-described embodiments and various modifications may be made without departing from the scope of the present invention.

### Modified Example 1

For example, the second coating region 10a is a region to be the body part 10 including the cylinder part 11 and the tapered part 13 in the above-described embodiment; however, it is not limited to this, the second coating region may be divided to a plurality of regions with a different apply amount of ink (per unit area).

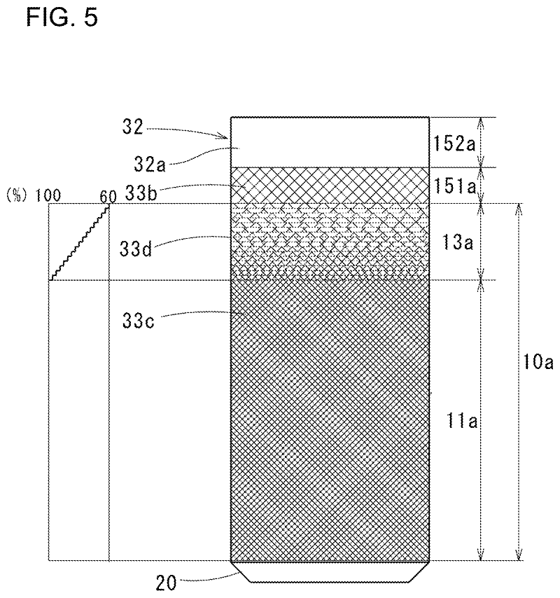

For example, as shown in FIG. 5, it is applicable that the second coating region 10a is formed from a third coating region 11a to be the cylinder part 11 and a fourth coating region 13a to be the tapered part 13 and that an apply amount of ink on the fourth coating region 13a (per unit area) is less than an apply amount of ink on the third coating region 11a (per unit area). In this case, furthermore, regarding the fourth coating region 13a, the apply amount of the ink (per unit area) may be reduced upward along the can axis C by gradation.

That is to say, in the above-described necking step, the shoulder part 12 and the tapered part 13 are formed by machining of reducing the diameter of the upper part than the cylinder part 11 of the body part 10. Accordingly, the printed layer 33 formed before the necking step is compressed in the circumference direction on the tapered part 13 and becomes thicker than that before the necking step. In the other words, the apply amount of the ink per unit area is larger than before the necking step. Accordingly, from the shoulder part 12 to the tapered part 13, cracks and peelings easily occur because strain by machining deformation is also remained.

Therefore, the apply amount of the ink per unit area may be modified in the printing step so that the thickness of the printed layer 33 after the necking step is substantially the same in the cylinder part 11, the shoulder part 12 and the tapered part 13. Moreover, also after the mouth part forming step, the apply amount of the ink per unit area in the printing step may be adjusted for the respective regions so that the thickness of the printed layer 33 of the swelled part 151 is smaller than or the same as the thickness of the printed layer 33 in the shoulder part 12 and the tapered part 13.

In the necking step, the diameter reduction ratio of the tapered part 13 is gradually increased from a boundary to the cylinder part 11 (the shoulder part 12) toward the mouth part 15. Accordingly, the dot density is decreased by changing one or both of a dot diameter and the screen ruling continuously to fit for the increase of the diameter reduction ratio of the tapered part 13, so that the apply amount of the ink (per unit area) in the fourth coating region 13a is gradually reduced from the boundary of the third coating region 11a which becomes the cylinder part 11 after forming toward the first coating region 151a.

For example, as shown in FIG. 5, an applicable configuration is such that a third printed layer 33c of the third coating region 11a is formed with solid printing of density 100%, the dot density of a fourth printed layer 33d of the fourth coating region 13a is gradually decreased from the boundary of the third coating region 11a toward the first coating region 151a so that the density is set to be 60% at the tip end at the upper side in the can axis direction of the fourth coating region 13a (the boundary of the first coating region 151a). In FIG. 5, the dot density is decreased step by step from the boundary of the third coating region 11a toward the first coating region 151a; however, it can be decreased continuously (linearly).

As described above, by necking the cylinder body 32 which is printed with the different dot density between the third coating region 11a and the fourth coating region 13a in the necking step, it is possible to adjust the depth and a color tone of the printed layer 33 between the cylinder part 11 and the tapered part 13, and it is also possible to reduce the thickness of the printed layer 33 in the tapered part 13 and to prevent the cracks and the like in the printed surface after the content is filled and retort sterilization and the like are carried out.

### Modified Example 2

In the printing step (the outer surface printing and coating step), the outer peripheral surface 32a of the cylinder body 32 may be printed using a first printing block transcribing the ink on both the first coating region 151a and the second coating region 10a and a second printing block transcribing the ink only on the second coating region 10a. In this case, since the second printing block does not transfer the ink on the first coating region 151a, it is easy to reduce the apply amount of ink per unit area of the first coating region 151a comparing to that of the second coating region 10a.

### Modified Example 3

In the above embodiment, the apply amount of the ink on the first coating region 151a is less than the apply amount of the ink on the second coating region 10a by changing the dot density between the first coating region 151a and the second coating region 10a; however, it is not limited to this, it is appliable that the first coating region 151a is dot printed the second coating region 10a is solid printed.

### Modified Example 4

In the printing step (the outer surface printing and coating step), it is applicable that the first coating region 151a is dot printed and the first coating region 151a the first printing block for solid printing is used on the second coating region 10a so that the second coating region 10a are both coated with the ink, and then, furthermore, the ink is coated on both the first coating region 151a and the second coating region 10a using the second printing block for solid printing on both the first coating region 151a and the second coating region 10a.

In this case, since the second coating region 10a is solid printed twice, it is possible to add to the beauty of the cylinder part 11 and the tapered part 13. While, since the first coating region 151a is dot printed and then solid printed, the apply amount of the ink on the first coating region 151a can be reliably less than the apply amount of the ink on the second coating region 10a.

### Modified Example 5

The cylinder body having the base part which is formed integrally is used; however, the base part does not need to be formed integrally; it is applicable that a base part which is formed apart is mounted. In this case, a mounting step of the base part may be before or after the printing step.

### Modified Example 6

It is applicable that a base coat and a size coat are formed on the outer peripheral surface 32a of the cylinder body 32 before the printing step (the outer surface printing and coating step).

### INDUSTRIAL APPLICABILITY

In the bottle can in which the cylinder body is largely deformed after the printing step, it is possible to improve the adhesiveness of the ink, and to reduce the peeling of the print when the cap is opened and the torque when it is opened; and also adjust the color tone of the printed surface.

### REFERENCE SIGNS LIST

10 Body part
10a Second coating region
11 Cylinder part
11a Third coating region
12 Shoulder part
23 Tapered part
13a Fourth coating region (Second coating region)
15 Mouth part
151 Swelled part
152 Male thread part
151a First coating region
18 Small-diameter part
20 Base part
31 Cup
32 Cylinder body
32a Outer peripheral surface
33 Printed layer
33a Second printed layer
33b First printed layer
33c Third printed layer
33d Fourth printed layer
35 Bottle-shape can
50 Printing machine
60 Ink adhesion mechanism
61 Inker unit
62 Printing plate cylinder
63 Blanket cylinder
64 Blanket
72 Mandrel
73 Mandrel
75 Roll coater
101 Bottle can
102 Cap
102a Slit

1. A manufacturing method of a bottle can comprising:
a printing step printing on an outer peripheral surface of a cylinder part of a cylinder body;
a necking step forming a tapered part in which a diameter is reduced upward from the cylinder part and a small-diameter part extending toward the upper side of the tapered part by deforming the cylinder body after the printing step; and
a mouth part forming step forming the mouth part having a swelled part and a male thread part by deforming the small-diameter part; wherein
in the printing step, ink is applied on a third coating region to be the cylinder part, a fourth coating region to be the tapered part, and a first coating region to be the swelled part, and
an apply amount of the ink per unit area in the first coating region is less than an apply amount of the ink per unit in the third coating region.

2. The manufacturing method of a bottle can according to claim 1, wherein an apply amount of the ink per unit area in the fourth coating region is less than the apply amount of the ink per unit area in the third coating area and gradually reduced upward.

3. The manufacturing method of a bottle can according to claim 1, wherein an apply amount of the ink per unit area in the fourth coating area is the same as the apply amount of the ink per unit area in the third coating area.

4. The manufacturing method of a bottle can according to claim 1, wherein in the printing step, a first printing block transcribing the ink on both the first coating region and a second coating region including the third coting region and the fourth coating region and a second printing block transcribing the ink on the second coating region only are used.

5. The manufacturing method of a bottle can according to claim 1, wherein in the printing step, one printing block is used having a first region transcribing the ink to the first coating region and a second region transcribing more amount of the ink than in the first region to a second coating region including the third coating region and the fourth coating region.

6. The manufacturing method of a bottle can according to claim 1, wherein in the printing step, the first coating region and a second coating region including the third coating region and the fourth coating region are dot printed; and a dot density of the ink printed on the second coating region is higher than a dot density of the ink printed on the first coating region.

7. The manufacturing method of a bottle can according to claim 1, wherein in the printing step, the first coating region is dot printed and a second coating region including the third coating region and the fourth coating region is solid printed.

8. The manufacturing method of a bottle can according to claim 1, wherein in the printing step,
while using a first printing block transcribing the ink to both the first coating region and a second coating region including the third coating region and the fourth coating region, the first coating region is dot printed and the second coating region is solid printed; and
while using a second printing block transcribing the ink to both the first coating region and the second coating region, the first coating region and the second coating region are solid printed.

9. A bottle can comprising:
a cylinder part; a tapered part in which a diameter is reduced upward from a top end of the cylinder part; and a mouth part which is provided at an upper side of the tapered part and has a swelled part swelled outward in a radial direction and a male thread part, wherein
a printed layer is formed on the cylinder part, the tapered part and the swelled part, and
a thickness of the printed layer on the swelled part is smaller than a thickness of the printed layer on the cylinder part.

10. The bottle can according to claim 9, wherein an inclined angle by the tapered part and a can axis of the cylinder part are not less than 10° and not more than 41°.

11. A manufacturing method of a bottle can comprising a cylinder part of a cylinder body having a printed outer peripheral surface, wherein
an apply amount of ink per unit area in a first coating region to be a swelled part of the bottle can is less than an apply amount of ink per unit area in the other region.

12. A manufacturing method of a bottle can formed by reducing a diameter of an open side of a cylinder part having a base part, wherein
an apply amount of ink per unit area in a first coating region in the cylinder part to be a swelled part of the bottle can is less than an apply amount of ink per unit area in the other region.
